(19) United States
(12) Patent Application Publication
(10) Pub. No.: US 2006/0164332 A1
(43) Pub. Date: Jul. 27, 2006

(54) Method for fabricating a plastic molded indicator symbol and a plastic molded indicator symbol

(75) Inventors: Mikkola Matti, Helsinki (FI); Nissinen Timo, Vaajakoski (FI); Simo Vahamottonen, Jarvenpaa (FI); Hannu Lehmussaari, Helsinki (FI); Seppo Toivanen, Klaukkala (FI)

Correspondence Address: BANNER & WITCOFF, 1001 G STREET N W, SUITE 1100, WASHINGTON, DC, 20001, US

(73) Assignee: Nokia Corporation

(21) Appl. No.: 10/510,443

(22) PCT Filed: Apr. 14, 2003
(86) PCT No.: PCT/FI03/00281

§ 371 Date: Apr. 14, 2005

(30) Foreign Application Priority Data
Apr. 19, 2002 (FI) 20020761

(51) Int. Cl. B29C 45/00; B32B 27/08; G09G 3/00

(52) U.S. Cl. 345/32; 264/328.1; 428/35.7; 340/815.45

(57) ABSTRACT

A method for fabricating a homogeneous plastic molded object and a plastic molded object comprising a first surface and second surface, which second surface. further comprises a symbol-shaped hollow such that the object transmits light within the area of the hollow. The fabrication method for a plastic molded object comprises steps in which a polycarbonate compound is melted and injected under pressure in a mold cavity.

The present invention relates to a plastic molded indicator symbol and a method for fabricating a plastic molded object which plastic molded object comprises said indicator symbol.

### BACKGROUND

Indicator symbols are known to be used to indicate to the user of an electronic device operating states or error conditions in the device. Manufacture of indicator symbols has involved different fabrication methods such as silk screen printing or the two-component method.

Silk screen printing has been used e.g. to fabricate indicator symbols for instrument boards of vehicles, where indicator symbols are used to indicate to the driver of the vehicle different states associated with the functioning of the vehicle or various error conditions, one example being a red symbol of the battery of the vehicle which, when it lights up while the engine is running, indicates a fault in the charging system of the vehicle. In silk screen printing, color layers are printed on a plastic film to achieve light transmission and coloring. An indicator symbol, such as the warning symbol mentioned above, is lit by a lamp or led behind said symbol so that the symbol becomes prominently visible.

The two-component method is another fabrication method that has been used in the manufacture of indicator symbols. At the first stage of this fabrication method an object is cast of opaque plastic material, comprising a hole through the object at that point in the object where the indicator symbol is to be placed. Advantageously the hole is shaped like the indicator symbol, whereby at the second stage, a transparent and preferably colored plastic material is cast in the hole. Another way to fabricate an object comprising an indicator symbol is to separately fabricate the object and the indicator symbol from different materials and to join these components by gluing, for example.

The constructions of the indicator symbols described above are disadvantageous in that they comprise several separate parts attached to one another. Moreover, the fabrication methods require a plurality of manufacturing steps in order to achieve the desired end product. The more manufacturing steps in the fabrication method, the more complex and expensive the equipment needed in the fabrication and the longer the time required for the fabrication. Furthermore, using a plurality of fabrication materials means higher production costs e.g. in the form of raw materials and storage costs.

### SUMMARY OF THE INVENTION

Now it has been invented a method for fabricating a plastic molded object comprising at least one indicator symbol, and a plastic molded object comprising at least one indicator symbol. The plastic molded object according to the invention has a homogeneous structure. The indicator symbol is integrated in the plastic molded object so that the entity constitutes one single piece. Especially, but not necessarily, the method relates to the fabrication of a housing component of an electronic device, which housing component comprises at least one indicator symbol. Advantageously the fabrication method includes only one manufacturing stage in which molten plastic raw material is injected under pressure in a mold cavity whereby a plastic object complete with indicator symbol is produced in a single manufacturing stage.

According to a first aspect of the invention, it is provided a method for fabricating a plastic object comprising at least one indicator symbol, characterized in that the method comprises steps in which molten plastic raw material is injected in a mold cavity to produce a homogeneous plastic object, which mold cavity comprises a first mold surface having an embossment shaped like an indicator symbol, a second mold surface at a distance from said first mold surface, and a cavity between said first mold surface and said second mold surface to hold plastic raw material.

According to a second aspect of the invention, it is provided a plastic object, characterized in that said plastic object is of a homogeneous material and comprises a visually perceptible symbol and said plastic object further comprises a first surface comprising a hollow shaped like the symbol, which bottom surface formed by the hollow is arranged so as to transmit light emitted by a light source and said bottom surface is of said homogeneous material, a second surface located on the opposite side of the plastic object with respect to said first surface, on which said symbol is intended to be visually perceptible when light is emitted from the side of said first surface.

According to a third aspect of the invention, it is provided an electronic device comprising at least one housing element defining a space within it, a printed circuit board fitted in said space, and at least one light source fitted on said printed circuit board, characterized in that said housing element is of a homogeneous material and further comprises a first surface comprising a hollow shaped like a symbol, whereby said at least one light source is arranged so as to emit light into said hollow and the bottom surface formed by the hollow is arranged so as to transmit light emitted by said light source and which bottom surface is of said homogeneous material, a second surface located on the opposite side of the housing element with respect to said first surface, and said second surface is intended to be the exterior surface of the device, on which exterior surface said symbol is intended to be visually perceptible when said light source is emitting light.

Advantages brought about by the homogeneous plastic object according to the invention include single-stage manufacture, resulting in simple and quick fabrication of the product. Another advantage of the invention is that it decreases manufacturing costs, which is advantageous especially in mass production of industrial scale. A single manufacturing stage makes it possible to fabricate objects according to the invention without complex and expensive machinery and equipment, and without logistics chains between the different work stages or manufacturers. Moreover, the fabrication of plastic molded objects according to the invention is advantageous even with small production quantities. The plastic object according to the invention is advantageously a housing component of an electronic device comprising at least one indicator symbol.

The invention will now be described in detail, referring to the accompanying drawings, where

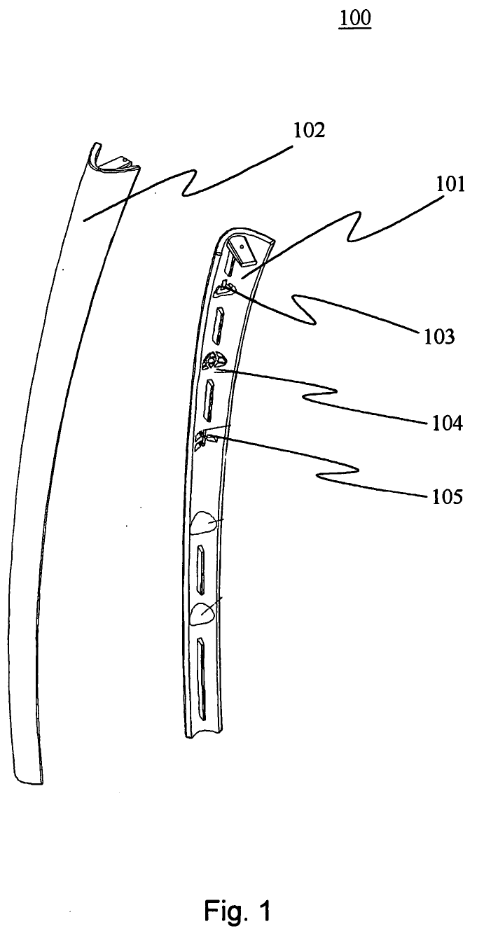

FIG. 1 shows a plastic molded object according to an embodiment of the invention,

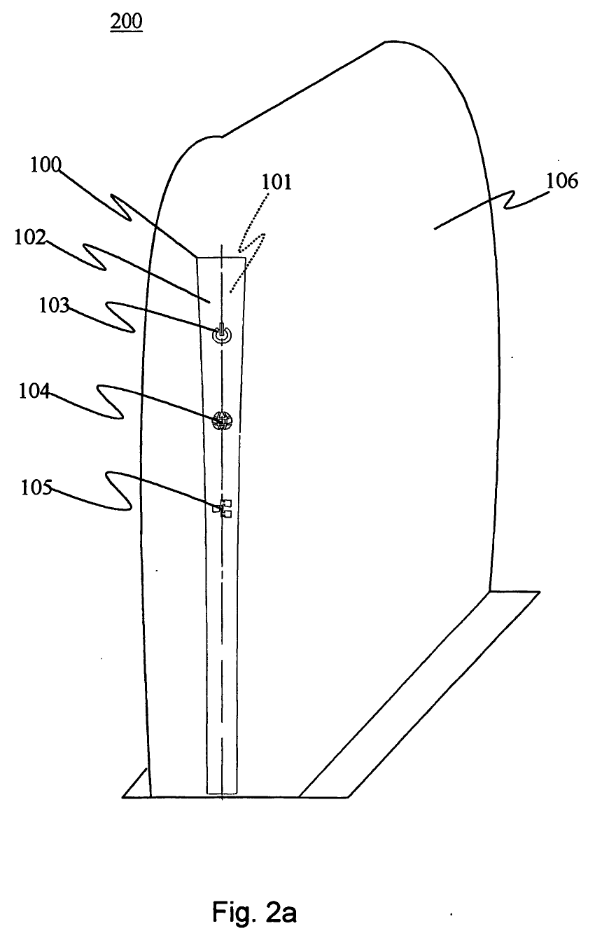

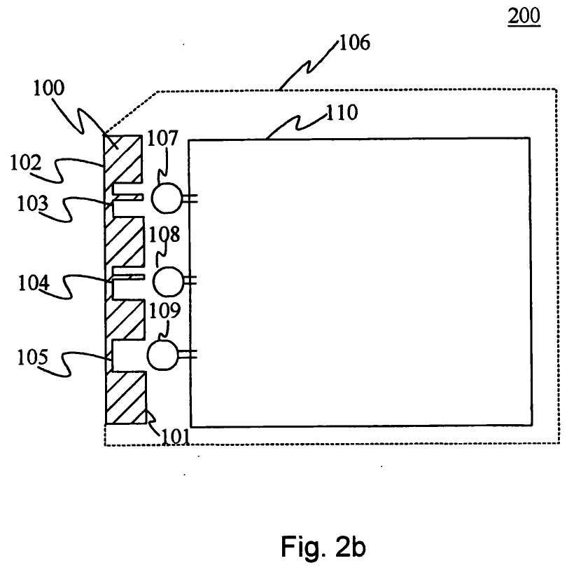

FIG. 2a shows an electronic device according to an embodiment of the invention,

FIG. 2b shows a cross section of the electronic device of FIG. 2a,

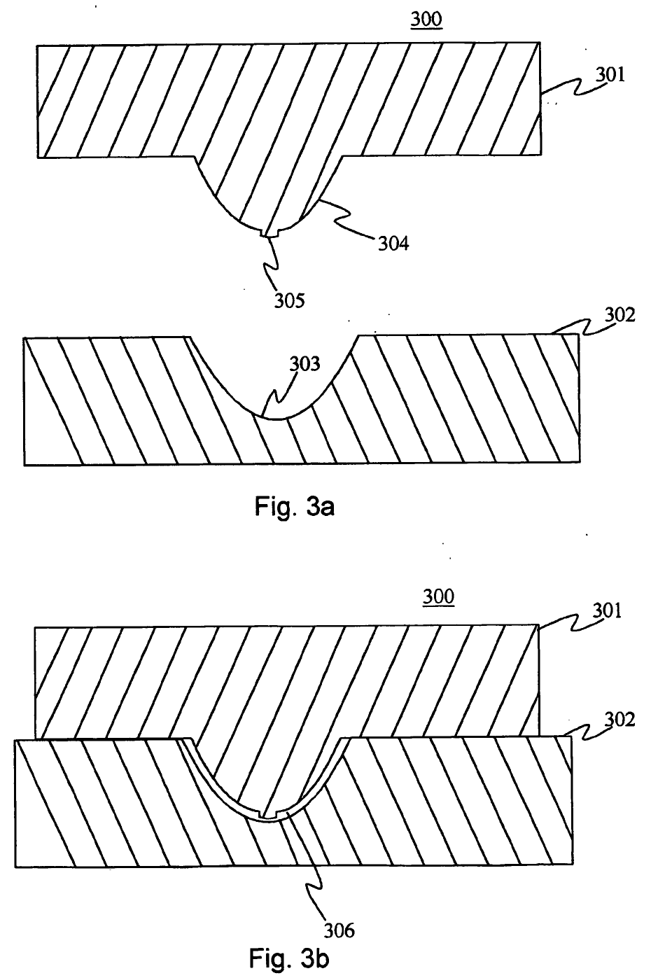

FIG. 3a shows the elements of a mold, and

FIG. 3b shows the elements of a mold placed one against the other.

As an illustrative example FIG. 1 shows a plastic molded object 100 according to an embodiment of the invention, i.e. a portion of the housing structure of an ADSL gateway device. The invention is not limited to the example described here, but it can be applied to the fabrication of other objects, too, which comprise an indicator symbol. The plastic molded object according to the invention is advantageously applied e.g. in products based on wireless technology such as Wireless Access Points or wireless terminals such as Customer Premises Equipment (CPE). The plastic molded object 100 comprises indicator symbols 103-105 fabricated in conjunction with the fabrication of said object by injecting molten plastic, such as a polycarbonate compound, under pressure into a mold cavity in one and the same work stage. The plastic molded object 100 comprises a first surface 101 which advantageously is the inner surface of the object, and a second surface 102 which advantageously is the outer surface of the object. The indicator symbols 103-105 are formed on surface 101 as hollows, whereby the object 100 transmits light at said hollows. The outer surface 102 of the plastic molded object 100 advantageously reflects light whereby said indicator symbols are visually imperceptible when viewed from the side of surface 102 and when the symbols are not lit from the side of surface 101. A reflecting surface is advantageously produced in such a manner that the surface of the mold which corresponds to surface 102 of the object, is smoothed using e.g. diamond paste of a certain roughness (advantageously from 4 to 8 micrometers). The molten plastic raw material will solidify against the polished surface, resulting in a smooth and reflecting surface. Each indicator symbol can be seen only when it is lit by a light source such as a lamp or led from the side of surface 101, advantageously from inside the device. The other surface 101 of the plastic molded object 100 does not reflect light advantageously at that point where the indicator symbol is located. The surface shall be roughened so that light emitted by the light source will scatter and not pass through the hollow spotlike, whereby the indicator symbol in its desired shape will be visually conveyed to a person looking at the object from the side of surface 102. A roughened surface is advantageously produced in such a manner that the surface of the mold which corresponds to the inner surface 101 of the object 100, is arc machined. An arc machined surface in the mold is required only at the locations of the symbols on the inner surface 101.

The distance between the surfaces 101 and 102 of the plastic molded object 100, i.e. the thickness of the object, is advantageously 1.5 mm, but it may deviate from that depending, for instance, on the use of the object 100 and, thus, on the strength and durability required thereof. In the plastic molded object 100 of the example case the distance between the surfaces 101 and 102, i.e. the thickness of the wall, is advantageously 0.25 mm at the locations of the indicator symbols 103-105, but it may deviate from that depending, for instance, on the intensity and color of the light used for the lighting of the symbol, and on the transparency of the plastic compound used in the object 100. The thickness of the wall in the symbol area of the object is advantageously 15 to 20% of the thickness of the object elsewhere. This ratio depends e.g. on the intensity of the lighting and on the color of the light used, which may be e.g. red or green, as well as on the transparency of the plastic compound used in the object 100. The thicker portion of the object 100, which above was stated to have a thickness of 1.5 mm, will not transmit light. The object 100 will transmit light only in the areas of the thinner portion, i.e. the indicator symbols 103-105, which above was stated to have a thickness of 0.25 mm.

The plastic molded object 100 is fabricated by injecting a molten polycarbonate compound under pressure in a mold cavity. The object 100 and the indicator symbols 103-105 are usually fabricated in one and the same work stage. The object 100 has a homogeneous structure and is therefore advantageously more durable than a prior-art object which is fabricated of two separate pieces e.g. by gluing the pieces together. One of the advantages of a single manufacturing stage is e.g. that less machines are needed to fabricate the object. Moreover, potential intermediate storage is not required between different work stages.

The plastic molded object 100 is advantageously made of a polycarbonate compound which may comprise e.g. polycarbonate Lexan 121R-7104 and polycarbonate Lexan 123R-705780LM in a proportion in which there are substantially equal amounts of both polycarbonates. Advantageously, 100% of polycarbonate compound according to the invention comprises 50% polycarbonate Lexan 121R-7104 and 50% polycarbonate Lexan 123R-705780LM. This mixture ratio produces a plastic molded object which is durable enough in the indicator symbol area. Furthermore, the wall of the indicator symbol will be sufficiently thin to transmit light and allow the symbol to be perceived on the side of the outer surface 102. Fabrication of the plastic molded object is not limited to the use of the polycarbonate compound mentioned above but other polycarbonate compounds can be used such as Lexan 121RBK1A112X, for example.

FIG. 2a shows an electronic device 200 according to an embodiment of the invention, comprising advantageously in the housing of the device 200 the plastic molded object 100 depicted in FIG. 1. For reasons of clarity, the indicator symbols 103-105 shown in FIG. 2 are presented as if they were all illuminated from inside the device. The electronic device 200 is e.g. an ADSL gateway the front panel of which comprises the plastic molded object 100. In another embodiment the electronic device is advantageously a mobile station or a modem the housing of which comprises the plastic molded object 100.

FIG. 2b shows a cross section of an electronic device 200 comprising a printed circuit board 110 with one or more light sources (107-109) such as e.g. lamps or leds, advantageously located beside the indicator symbols 103-105 of the plastic molded object 100 on the side of surface 101. Suitable light sources are e.g. SIEMENS LGA 670-L leds. The distance of a light source from the bottom of an indicator symbol hollow is advantageously about 10 to 15 mm. Housing element 100 and housing element 106 can be fabricated separately and attached to each other by means of gluing, for example, in conjunction with the assembly of the device 200. Alternatively, the elements 100 and 106 may constitute a single piece fabricated in one and the same stage. The hollows depicted in FIG. 1 in the object 100 at the led locations in the housing of the device on the side of surface 102 (not visible in FIG. 2b) enable visual perception of the indicator symbols 103-105 when the led is on. Conversely, when an indicator symbol 103-105 is not illuminated the object 100 seems substantially opaque, i.e. the indicator symbol 103-105 is not visible when viewed from the direction of surface 102. The plastic molded object and fabrication method according to the invention are not limited to that which is described above but the plastic object according to the invention can be used as a component part in any applicable electronic device.

FIG. 3a shows a cross section of a mold 300 for the plastic molded object depicted in FIG. 1, comprising a first element 301 and second element 302. A surface 304 of the first element 301 corresponds to surface 101 of the plastic object shown in FIG. 1. Surface 304 comprises an embossment 305 shaped like an indicator symbol. The second element comprises a surface 303 which corresponds to surface 102 of the plastic object 100 shown in FIG. 1. Surface 304 of the first element 301 is arc machined at a location corresponding to the symbol-shaped embossment 305. This causes light emitted by a light source to scatter and not to pass spotlike through the hollow of the symbol location, whereby the indicator symbol will be visually perceptible when viewed from the direction of surface 102 and when the symbol is illuminated from the direction of surface 101. Surface 303 of the second element 302 is polished using diamond paste, for example, so that the corresponding surface 102 of the plastic object 100 becomes smooth and reflective, whereby the symbol cannot be perceived on the outer surface 102 when it is not illuminated from the direction of the inner surface 101.

FIG. 3b shows a cross section of the mold 300 with element 301 and 302 pressed one against the other. The distance between the surfaces of the mold 300 shown in FIG. 3a, when surfaces 301 and 302 are placed one against the other, is 1.5 mm for surfaces 303 and 304. The distance between the embossment 305 and surface 303 is 0.25 mm. The plastic raw material is advantageously a polycarbonate compound comprising e.g. polycarbonate Lexan 121R-7104 and polycarbonate Lexan 123R-705780LM as was described above. The cavity 306 between elements 301 and 302 defines a space into which the molten plastic raw material is injected. Thus is produced a plastic molded object with a transparent symbol in a single manufacturing stage.

Implementation and embodiments of the invention were described above with the help of illustrative examples. It is obvious to a person skilled in the art that the invention is not limited to the details of the above embodiments and that the invention can be implemented in some other form, too, without departing from the characteristics of the invention. The embodiments presented here should be construed as illustrative and not restrictive. Thus the implementation and application of the invention are limited only by the claims attached hereto. Therefore, various alternative implementations of the invention defined by the claims, including equivalent implementations, fall into the scope of the invention.

1. A method for fabricating a plastic object (100) comprising at least one indicator symbol (103-105), characterized in that the method comprises steps in which
molten plastic raw material is injected in a mold cavity to produce a homogeneous plastic object, which mold cavity comprises
a first mold surface (304), which first mold surfacesurface comprises an embossment (305) shaped like an indicator symbol (103-105),
a second mold surface (303) at a distance from said first mold surface, and
a cavity (306) between said first mold surface and said second mold surface to hold plastic raw material.

2. A method according to claim 1, characterized in that said embossment is arc machined on said first surface.

3. A method according to claim 1, characterized in that said second surface is polished.

4. A method according to claim 1, characterized in that said plastic raw material is a polycarbonate compound which comprises polycarbonate Lexan 121R-7104 and polycarbonate Lexan 123R705780LM substantially in equal amounts.

5. A method according to claim 4, characterized in that 100% of said polycarbonate compound comprises 50% polycarbonate Lexan 121R-7104 and 50% polycarbonate Lexan 123R705780LM.

6. A method according to claim 1, characterized in that said first mold surface is arranged so as to constitute a first surface of said homogeneous plastic object, which first surface comprises a symbol-shaped hollow at the location of said embossment, which bottom surface formed by the hollow is arranged so as to transmit light emitted by a light source and which said bottom surface is of said homogeneous material.

7. A method according to claim 1, characterized in that said second mold surface is arranged so as to constitute a second surface of said homogeneous plastic object, which second surface is located on the opposite side of the plastic object with respect to said first surface, on which said symbol is intended to be visually perceptible when light is emitted from the side of said first surface.

8. A plastic object (100), characterized in that said plastic object (100) is of a homogeneous material and comprises a visually perceptible symbol and said plastic object further comprises
a first surface (101), which first surface comprises a hollow (103-105) shaped like the symbol, which bottom surface formed by the hollow is arranged so as to transmit light emitted by a light source and said bottom surface is of said homogeneous material,
a second surface (102), which second surface is located on the opposite side of the plastic object (100) with respect to said first surface, on which said symbol (103-105) is intended to be visually perceptible when light is emitted from the side of said first surface.

9. A plastic object according to claim 8, characterized in that said object is made of homogeneous plastic molded material.

10. A plastic object according to claim 9, characterized in that the plastic molded material comprises a polycarbonate compound which further comprises polycarbonate Lexan 121R-7104 and polycarbonate Lexan 123R705780LM substantially in equal amounts.

11. A plastic object according to claim 10, characterized in that 100% of said polycarbonate compound comprises 50% polycarbonate Lexan 121R-7104 and 50% polycarbonate Lexan 123R705780LM.

12. A plastic object according to claim 8, characterized in that said second surface reflects light.

13. A plastic object according to claim 8, characterized in that said surface of the area of the hollow does not reflect light and it is arranged so as to transmit light from the side of said second surface to the side of said first surface.

14. An electronic device (200) comprising at least one housing element (100, 106) defining a space within it, a printed circuit board fitted in said space, and at least one light source (107-109) fitted on said printed circuit board, characterized in that said housing element (100, 106) is of a homogeneous material and further comprises
a first surface (101), which first surface comprises a hollow (103-105) shaped like a symbol, whereby said at least one light source (107-109) is arranged so as to emit light into said hollow (103-305) and the bottom surface formed by the hollow is arranged so as to transmit light emitted by said light source and which bottom surface is of said homogeneous material,
a second surface (102), which second surface is located on the opposite side of the housing element (100, 106) with respect to said first surface, and said second surface is intended to be the exterior surface of the device (200), on which exterior surface said symbol (103-105) is intended to be visually perceptible when said light source is emitting light.

15. An electronic device according to claim 14, characterized in that at least one hollow (103-105) in said housing element is fitted on the inner surface of the housing element in such a manner that said symbol cannot be visually perceived from the side of the outer surface of the device when the light source is not emitting light.

16. An electronic device according to claim 14, characterized in that said housing element is made of a polycarbonate compound which comprises polycarbonate Lexan 121R-7104 and polycarbonate Lexan 123R705780LM.

17. An electronic device according to claim 16, characterized in that said polycarbonate compound comprises polycarbonate Lexan 121R-7104 and polycarbonate Lexan 123R705780LM substantially in equal amounts.

18. An electronic device according to any one of the preceding claims 14 to 17, characterized in that said device is at least one of the following: modem, mobile station, node or wireless terminal.
